(19) United States
(12) Patent Application Publication
(10) Pub. No.: US 2011/0017559 A1
(43) Pub. Date: Jan. 27, 2011

(54) PRESSURE RESERVOIR FOR SHOCK ABSORBER

(75) Inventor: Torkel Sintorn, Vaxholm (SE)

Correspondence Address: KNOBBE MARTENS OLSON & BEAR LLP, 2040 MAIN STREET, FOURTEENTH FLOOR, IRVINE, CA, 92614, US

(73) Assignee: OHLINS RACING AB, Upplands Vasby (SE)

(21) Appl. No.: 12/600,217

(22) PCT Filed: May 14, 2008
(86) PCT No.: PCT/SE2008/050565

§ 371 Date: Aug. 11, 2010

(30) Foreign Application Priority Data
May 16, 2007 (SE) 0701175-2

(51) Int. Cl. F16F 9/096; F16F 9/06; B60G 17/04

(52) U.S. Cl. 188/314

(57) ABSTRACT

A reservoir comprises an upper reservoir part and a lower reservoir part divided by a member into a first reservoir chamber and second reservoir chamber. The reservoir mounts to a shock absorber having a generally cylindrical body. At least the lower reservoir part is delimited by two parallel-displaced flat base surfaces and has a reservoir wall as a contacting surface between these base surfaces. The reservoir has a vertical extent that is substantially parallel with the shock absorber body. One of or both of the base surfaces of the lower reservoir part are kidney-shaped and are connected by the reservoir wall so that the lower pat of the reservoir has a vertical extent that partially follows the cylindrical shape of the shock absorber body

### CROSS-REFERENCE TO RELATED APPLICATIONS

This application is a U.S. National Phase of International Application No. PCT/SE2008/050565, filed May 14, 2008, which claims priority to Swedish Patent Application No. 0701175-2, which was filed on May 16, 2007.

### BACKGROUND OF THE INVENTION

1. Field of the Invention

The invention relates to a vessel or reservoir that is intended to pressurize a hydraulic shock absorber or a front fork on a two-wheeled or four-wheeled vehicle.

2. Description of the Related Art

Hydraulic shock absorbers having an external reservoir secured to a cylinder head that is connected to the shock absorber body, a so-called “piggyback solution,” have long been known. The external reservoir is intended to pressurize the damping medium in the shock absorber so that a certain excess pressure prevails and cavitation can be avoided. In addition, the pressurizing reservoir can absorb the piston rod displacement of damping medium or the damping medium increase results when the temperature of the damping medium increases. The pressurizing vessel is pressurized by a compressible medium, preferably gas in some form, which is more compressible than the damping medium, which is preferably oil with various additives. The damping medium is used to absorb force. The pressurizing medium acts upon a member having a certain active area upon which the increasing or decreasing damping medium volume also acts. The member that is positioned between the pressurizing medium and the damping medium therefore moves in dependence on the damping medium volume acting upon it.

In U.S. Pat. No. 4,271,869, a shock absorber having an external reservoir is described, in which the member that separates the compressible medium from the damping medium is an elastic rubber part, a so-called bladder.

The Applicant's own patent EP 1006292 shows a shock absorber having an external pressurizing reservoir, in which the separating member has the form of a circular piston that is intended to slide against the inner surface of the reservoir.

As vehicles become more and more advanced, the space in which the shock absorbers are to be fitted diminishes. It has therefore proved to be a problem to accommodate a vehicle shock absorber with an external reservoir in the diminishing space between the chassis/body and the ground. Previous solutions to the problem are to angle the reservoir in relation to the damping body, see, for example, U.S. Pat. No. 6,220,408, or, in relation to the damping body, to turn the cylinder head to which the reservoir is fastened, see, for example, U.S. Pat. No. 6,105,740. Another solution is to separate the reservoir from the damping body and connect the parts with a hose, see US 2003137122. The reservoir then can be placed where space is present. The length of the hoses means, however, that there are delays in the system and cavitation can occur more easily.

It can also be a problem to cool both the damping medium and the gas volume when the pressure reservoir has a circular cross section and thus a relatively small area that contacts the cooling external air. When the shock absorber is subjected to strong forces or high speeds for a lengthy period, the temperature of both the damping medium and the gas increases, which leads to an increase in pressure in the damping body and in the external reservoir. The temperature increase in the gas occurs, however, more slowly than the temperature increase in the damping medium. Because the interior of the shock absorber is initially pressurized with a certain gas pressure and because the gas is more compressible than the damping medium, the partition wall between the damping medium and the gas is moved such that the volume increase in the damping medium is absorbed by the simultaneous volume decrease that takes place in the gas. But because the volume of the gas also changes with a change in temperature, the total pressure in the shock absorber increases and an increased pressure can result in a change to the damping characteristics of the shock absorber. A good and rapid cooling of the damping medium therefore is necessary to prevent a volume increase in the gas. In patent WO 0071898, the problem of the increased gas pressure has been solved by the opening of a passage from the gas chamber, which releases the excess pressure. The result, however, is that the gas volume becomes too small when the temperature of the gas falls.

If an elastic rubber part is used as the pressurizing member, the pressurizing area is greater than if a floating piston is used. This also means that the heat exchange between the damping medium and the gas increases. At the same time, the rubber part better fills the reservoir and the oil volume against which the area of the rubber part acts is smaller and is extended over a larger cooling outer surface than the oil volume in a reservoir with piston. It has been shown, however, that the fact that the cooling area has a circular profile is not sufficient to optimally cool the damping medium and the gas.

### SUMMARY OF THE INVENTION

The object of the present invention is to provide a space-efficient shock absorber with an external pressurizing reservoir.

The invention further aims to gives a better and smoother working of the shock absorber by allowing a faster fall in temperature of the damping medium and the gas.

The invention relates to a reservoir comprising an upper reservoir part and a lower reservoir part divided by a member into a first and second reservoir chamber. The reservoir is intended to be joined together with a hydraulic shock absorber such that the reservoir can pressurize the hydraulic shock absorber. The hydraulic shock absorber comprises a substantially cylindrical shock absorber body consisting of a damping cylinder having an inner damping chamber filled with a damping medium. The damping cylinder is delimited at both of its ends by fastening members and the damping cylinder is divided by an axially movable main piston. The reservoir is fixed to one of the fastening members. At least the lower reservoir part is delimited by two parallel-displaced flat base surfaces and has a reservoir wall as a contacting surface between these base surfaces. The reservoir also has a vertical extent that is substantially parallel with the shock absorber body. The invention is characterized in that that one of or both of the base surfaces of the lower reservoir are kidney-shaped and are connected by the reservoir wall so that the lower part of the reservoir has a vertical extent which partially follows the cylindrical shape of the shock absorber body. This design produces a compact shock absorber construction and a reservoir that has a greater heat exchange with the environment such that the temperature of the damping medium can be lowered.

The shape of the reservoir can also be described by stating that the reservoir wall of the lower reservoir part that faces toward the shock absorber body has an inner surface that substantially follows the cylindrical shape of the shock absorber body. The part of the reservoir wall of the lower reservoir part that faces away from the shock absorber body has an outer surface arranged at a greater radial distance from the shock absorber body than the inner surface. Between the inner and the outer surface a space is formed, which creates the desirable reservoir chamber. Because the outer surface is larger, a larger cooling area is created for the damping medium present in the reservoir.

In order to create a simple and durable construction, the outer and the inner surface have a smooth transition to one another, which is connected to a radius.

In a first embodiment of the invention, the upper reservoir part connects to the lower reservoir part and together forms a unit that, at its upper end, is connected to the cylinder head. In the first embodiment, the upper reservoir part and the lower reservoir part are produced from one material piece and, in a second embodiment, the upper reservoir part and the lower reservoir part are produced as two separable units.

In a third embodiment, the inner surface of the lower reservoir part is arranged at a distance from the shock absorber body. This distance is adapted to the dimensions of the spring of the shock absorber and it also has sufficient tolerance that allows a certain movement and full compression of the spring.

In a preferred embodiment, the reservoir is divided by an elastic member into a first reservoir chamber and a second reservoir chamber in which the first reservoir chamber is hydraulically connected to the damping-medium-filled damping chamber and the second reservoir chamber is filled by a gas. The gas acts upon the inner surface of the elastic member and pressurizes the first reservoir chamber. Since the member is elastic, the oil displacement that is created when the piston rod is pressed into the damping chamber can be taken up by the damping reservoir. The increase in damping medium volume that is formed when the oil expands at high temperature can also be taken up by the damping reservoir.

Preferably, the lower cross section of the elastic member is shaped to correspond to the base surface of the lower reservoir part, so that it, too, is kidney-shaped. The elastic member is fixed in the lower part of the reservoir by a cap secured in the reservoir by a locking ring, which engages in a groove in the reservoir or in the cap. The inner oil-filled volume of the reservoir is sealed against the environment by the lower part of the elastic member, which is also used as a seal between the cap and the inner surface of the reservoir.

### BRIEF DESCRIPTION OF THE DRAWINGS

The invention is described in greater detail below, with reference to the accompanying drawings.

FIG. 1 shows a hydraulic shock absorber having an external reservoir.

FIG. 2 shows a bottom view of the external reservoir fixed to the shock absorber.

FIG. 3 shows a sectional view of a hydraulic shock absorber having a reservoir according to the basic concept of the invention.

FIG. 4a shows a front view of a first embodiment of the reservoir.

FIG. 4b shows a view of a vertical section through the center of the reservoir and the elastic member.

FIG. 4c shows a top view of the reservoir.

FIG. 5 shows an alternative fastening of the reservoir to the cylinder head.

FIG. 6 shows a front view of a second embodiment of the reservoir.

### DETAILED DESCRIPTION OF THE PREFERRED EMBODIMENT

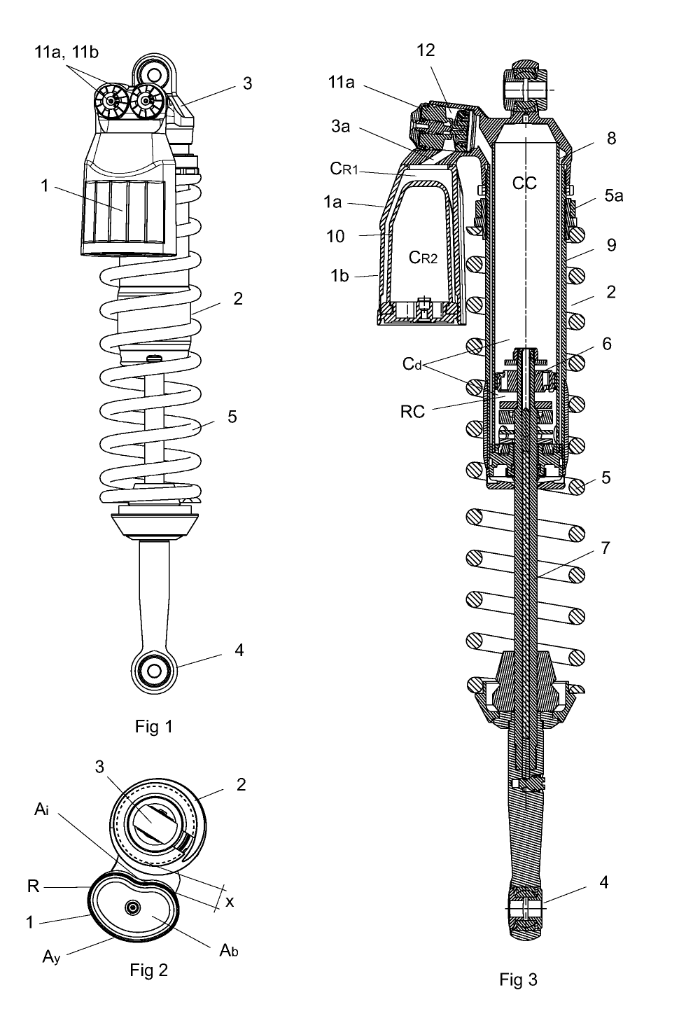

FIG. 1 shows a hydraulic shock absorber having an external reservoir 1 according to the invention. The shock absorber is made up of a damping body 2 having an outer diameter that is intended, with an upper fastening member or cylinder head 3, to be fastened to a vehicle chassis (not shown), for example a motorcycle, car or other vehicle and, with a lower fastening member 4, to be fastened to a wheel, a ski or a runner (not shown). The external reservoir 1 has a vertical extent and extends along and is arranged substantially parallel with the shock absorber body 2 with a certain distance x between the two parts 1, 2.

The reservoir 1 can be divided into an upper reservoir part 1a and a lower reservoir part 1b. These parts 1a, 1b can be arranged as a unit produced from one material piece or as two separable units. The second reservoir part 1b has the form of a kidney-shaped cylinder. A cylinder has an inner volume that is delimited by two parallel-displaced flat base surfaces and a contacting surface that joins together the base surfaces. The contacting surface is constituted in this case by a reservoir wall such that a reservoir chamber CR is formed. The upper reservoir part 1a connects the lower reservoir part 1b to the upper fastening member 3 of the shock absorber, but can also, in another embodiment, be connected to the lower fastening member 4.

FIG. 2 shows a bottom view of the reservoir and its base surfaces Ab when it is secured in the shock absorber. The base surfaces Ab of the lower reservoir part 1b are kidney-shaped. This means that the inner part of the reservoir wall of the lower reservoir part 1b, i.e. the surface facing toward the shock absorber body 2, is a concave surface Ai in relation to the center line of the reservoir, which concave surface Ai substantially follows the cylindrical shape of the shock absorber body 2. The surface Ai therefore curves only in one direction. The outer part of the reservoir wall of the lower reservoir part 1b, i.e. the surface facing away from the shock absorber body 2, is a convex outer surface Ay, which has a larger area than the inner surface Ai. The outer surface Ay is also arranged at a greater distance from the shock absorber body 2 than the inner surface Ai. In order to create the kidney shape of the base surfaces Ab of the reservoir, the outer surface Ay and the inner surface Ai have a smooth transition to one another, i.e. they are connected by a radius R determined by the radial distance between the inner and the outer contacting surface.

The inner surface Ai substantially follows the cylindrical shape of the damping body 2 at a radial distance x from the outer diameter of the damping body and this distance is substantially constant over the whole of the inner surface Ai. The distance can vary, but in the first embodiment of the invention it must be of such a size that a helical spring 5 can be introduced between the damping body 2 and the reservoir 1. The helical spring 5 must also be able to be compressed without risk of becoming jammed between the parts. Preferably, the distance x is between 10 mm and 20 mm. The distance is adapted to the spring dimensions by variation of the construction of the upper fastening device 3.

FIG. 3 shows the hydraulic shock absorber having the external reservoir 1 in cross section. The shock absorber is made up of the cylindrical shock absorber body 2 comprising a damping cylinder 8 which delimits an inner damping-medium-filled damping chamber Cd and comprises a main piston 6 fixed to a piston rod 7. The main piston 6 is arranged to slide axially in the damping cylinder 8 when the shock absorber is subjected to an external force such that the main piston 6 moves in relation to the shock absorber body 2. The damping cylinder 8 is delimited by the main piston 6 into a first compression damping chamber CC and a second return damping chamber RC. The main piston 6 can comprise passages that allow a limited damping medium flow, or can be solid so that the damping medium flow is forced between the damping chambers via one or more external ducts. Around the damping cylinder 8 is arranged, in this embodiment, an outer tube 9, which is delimited at its upper end by the upper fastening device or the cylinder head 3. Between the outer tube 9 and the damping cylinder 8 a space is formed, in which damping medium can flow between the damping chambers such that this space can be said to constitute the abovementioned external ducts.

The spring 5 is placed around the shock absorber body 2. The spring 5 is in this case a helical spring, which is clamped between the lower fastening member 4 and a spring washer 5a that is threaded on the outer tube 9.

In a further embodiment (not shown), the helical spring has been replaced by a pneumatic spring, which is provided in a space between the outer tube 9 or the damping tube 8 and a further tube arranged concentrically outside this. The size of this space preferably substantially coincides with the space for the helical spring, i.e. the distance x between the outer tube 9 and the inner surface Ai of the reservoir.

An elastic member 10 divides the interior of the reservoir 1 into an oil-filled first reservoir chamber CR1 and a gas-filled second reservoir chamber CR2. The gas in the elastic member 10, which delimits the second reservoir chamber CR2, pressurizes the oil-filled first reservoir chamber CR1 with a certain basic pressure. The first reservoir chamber CR1 is connected to both damping chambers CC, RC. Between the first reservoir chamber CR1 and the respective damping chamber CC, RC, two separate adjustable valves 11a, 11b (see also FIG. 1) are arranged to generate damping force through restriction of a damping medium flow between the damping chambers CC, RC when the shock absorber is subjected to a compression stroke and a return stroke respectively, which lead to the main piston 6 acquiring a certain speed.

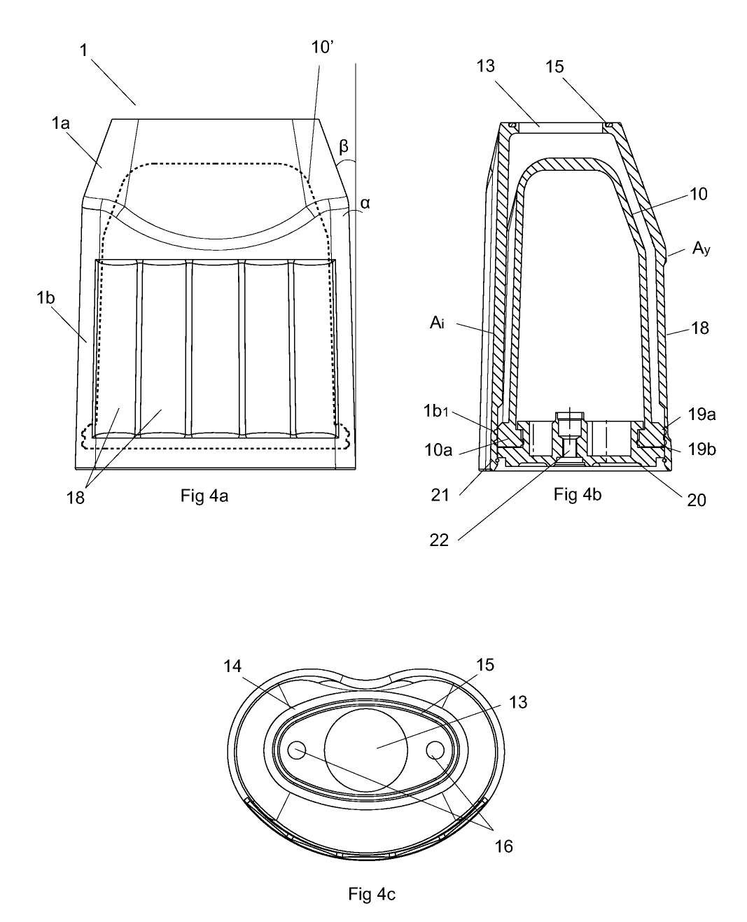

A duct 3a in the cylinder head connects the oil-filled first reservoir chamber CR1 in the reservoir 1 to a space 12 common to both valves 11a, 11b. The duct opens out into the reservoir 1 through a hole 13 made in the latter, see FIGS. 4a-4c.

FIGS. 4a-4c show various views of the reservoir 1. In this embodiment, the reservoir 1 is produced from a single basic material by water driving, casting, extrusion or the like.

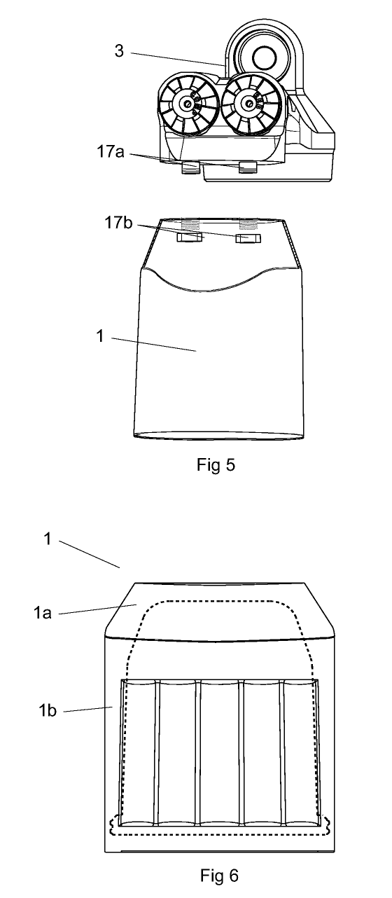

FIG. 4a shows a first embodiment, in which the outer, vertically extending surface of the reservoir body is angled at an angle α in relation to the perpendicular plane. This angle α is intended to adapt the reservoir 1 to the rounded upper shape of the elastic member 10, in FIG. 3a shown with a dashed line 10′, so that as small a damping medium volume as possible is disposed in the space between the elastic member 10 and the reservoir 1. An angle β greater than a closes off the upper part of the reservoir, which connects to the cylinder head 3 via an elliptical connection 14, see also FIG. 4c. In this elliptical connection 14 is arranged a groove 15, which is intended for a seal which will seal against the cylinder head 3. Two or more screw holes 16 are arranged on either side of the hole 13 connecting the inner damping medium volume of the reservoir to the damping medium volume of the respective damping chamber. In these screw holes 16, a screw joint is fitted, which binds together the reservoir and the cylinder head. An alternative embodiment for binding together the reservoir and the cylinder head is shown in FIG. 5, in which the cylinder head 3 is provided with threaded pins 17a, which are intended to cooperate with nuts 17b arranged in the interior of the reservoir. There are also other possible connection methods, for example press-fitting or riveting.

In order to lighten the reservoir, grooves 18 are milled in the outer surface Ay of the reservoir wall. Because the outer surface Ay is larger than the inner surface Ai, there is a more pressure-absorbing material on the outer side of the reservoir. The depth of the grooves is therefore adapted such that an approximately equal-sized total volume of pressure-absorbing material is kept on the outer surface as is the total volume on the inner surface.

FIG. 4b also shows the elastic member 10 and its fastening in the reservoir 1. The elastic member has a shape that extends from a base surface/lower part 10a, which is kidney-shaped and adapted to the base surface Ab of the reservoir, and which is tailored to follow the inner shape of the outer walls of the reservoir. The member 10 preferably is made of oil-resistant rubber, which can be die-cast or otherwise given the desired shape.

The elastic member 10 is fixed in the end part 1b1 of the reservoir by a cap 20 that is secured in the lower reservoir part 1b by a locking ring 21, which engages in a groove in the inner surface of the reservoir 1 or in the cap 20. The inner oil-filled first reservoir chamber CR1 of the reservoir 1 is sealed against the environment by the lower part 10a of the elastic member, which is also used as a seal between the cap 20 and the inner surface of the reservoir. That part of the member 10 which seals against the inner wall of the reservoir is configured with two raised edges 19a, 19b, which act as two mutually separated seals that prevent oil leakage. An advantageous pretensioning of the sealing edges 19a, 19b against the inner wall is created by tailoring the outer diameter of the cap 20 to the inner diameter of the reservoir. The inner volume of the elastic member 10 is filled with a gas, preferably nitrogen, via a hole 22 in the cap. The hole 22 is sealed against the environment via a screw and an air-tight material according to the prior art.

In a second embodiment of the reservoir 1 according to the invention, which is shown in FIG. 6, the reservoir 1 is extruded from a material so that the reservoir has mutually parallel sides. The upper reservoir part 1a has the form of a separate cap 23, which is sealed against and fastened to the lower reservoir part 1b either with press-fitting or with a threaded or bolted joint. Extending through this cap 23 is the hole connecting the reservoir and the respective damping chamber. The lower reservoir part 1a can also be fixed directly in the cylinder head 3, without the intermediate cap, through mutual matching of the bearing surfaces of the parts.

The invention is not limited to the embodiment shown above by way of example, but can be modified within the scope of the following patent claims and the inventive concept.

1. A reservoir comprising an upper reservoir part and a lower reservoir part divided by a member into a first reservoir chamber and a second reservoir chamber, the reservoir being intended to be joined together with and to pressurize a hydraulic shock absorber comprising a substantially cylindrical shock absorber body, the shock absorber body comprising a damping cylinder having an inner damping chamber filled with a damping medium and delimited at its ends by fastening members, the inner damping chamber is divided by an axially movable main piston, the reservoir is fixed to one of the fastening members and at least the lower reservoir part is delimited by two parallel-displaced flat base surfaces and a reservoir wall extending between these base surfaces, the reservoir has a vertical extent that is substantially parallel with the shock absorber body, and at least one of the base surfaces of the lower reservoir part being kidney-shaped and being connected to the reservoir wall so that the lower reservoir part has a vertical extent that partially follows the substantially cylindrical shape of the shock absorber body.

2. The reservoir as claimed in claim 1, wherein the the vertical extent of the lower reservoir part that partially follows the substantially cylindrical shape of the shock absorber body defines an inner surface an opposing portion of the reservoir wall of the lower part of the reservoir that faces away from the shock absorber body defines an outer surface that is arranged at a greater radial distance from the shock absorber body than the inner surface.

3. The reservoir as claimed in claim 2, wherein the outer surface and the inner surface are connected by a radius to have a smooth transition to one another.

4. The reservoir as claimed in claim 2, wherein the upper reservoir part connects to the lower reservoir part and together forms a unit that, at its upper end, is connected to the shock absorber body.

5. The reservoir as claimed in claim 4, wherein the upper reservoir part and the lower reservoir part are produced from one material piece.

6. The reservoir as claimed in claim 4, wherein the upper reservoir part and the lower reservoir part are produced as two separable units.

7. The reservoir as claimed in claim 2, wherein the inner surface of the lower reservoir part is arranged at a distance from the shock absorber body.

8. The reservoir as claimed in claim 2, wherein the reservoir is divided by an elastic member into a first reservoir chamber and a second reservoir chamber in which the first reservoir chamber is hydraulically connected to the damping-medium-filled damping chamber and the second reservoir chamber is filled by a gas that acts upon the inner surface of the elastic member and pressurizes the first reservoir chamber.

9. The reservoir as claimed in claim 8, wherein a lower cross section of the elastic member is shaped according to the base surface of the lower reservoir part so that the lower cross section of the elastic member is kidney-shaped.

10. The reservoir as claimed in claim 8, wherein the elastic member is fixed in the lower part of the reservoir by a cap that is secured in the reservoir.

11. The reservoir as claimed in claim 8, wherein the first reservoir chamber of the reservoir is sealed against the environment by a lower part of the elastic member.
